(19) United States
(12) Patent Application Publication
(10) Pub. No.: US 2017/0141399 A1
(43) Pub. Date: May 18, 2017

(54) Composite Electrode for an Electrochemical Cell and Electrochemical Cell

(71) Applicant: Bayerische Motoren Werke Aktiengesellschaft, Muenchen (DE)

(72) Inventors: Simon LUX, Oakland, CA (US); Ann-Christin GENTSCHEV, Belmont, CA (US); Odysseas PASCHOS, Muenchen (DE)

(21) Appl. No.: 15/417,285

(22) Filed: Jan. 27, 2017

Related U.S. Application Data
(63) Continuation of application No. PCT/EP2015/063461, filed on Jun. 16, 2015.

(30) Foreign Application Priority Data
Jul. 30, 2014 (DE) 10 2014 214 899.5

(51) Int. Cl. H01M 4/62; H01M 10/0525

(52) U.S. Cl. CPC H01M 4/623; H01M 10/0525

(57) ABSTRACT

A composite electrode for use in an electrochemical cell is provided having a conversion material and an elastic, conductive polymer binder. The conversion material includes at least one transition metal (M) and an anion (X). The transition metal can be completely reduced in a cell charging process of the electrochemical cell.

### CROSS REFERENCE TO RELATED APPLICATIONS

This application is a continuation of PCT International Application No. PCT/EP2015/063461, filed Jun. 16, 2015, which claims priority under 35 U.S.C. §119 from German Patent Application No. 10 2014 214 899.5, filed Jul. 30, 2014, the entire disclosures of which are herein expressly incorporated by reference.

### BACKGROUND AND SUMMARY OF THE INVENTION

The present invention relates to a composite electrode for use in electrochemical cells, in particular for use in lithium ion cells. The use of the composite electrode in the electrochemical cell of the invention provides excellent long-term stability.

Lithium ion batteries, also referred to as rechargeable lithium ion batteries, are particularly suitable for portable applications because of their high energy densities. A lithium ion battery cell typically includes an anode, a cathode and an electrolyte. Conventionally, composite electrodes used for the anodes and the cathodes can include not only active materials, namely components for lithium transport, lithium ion transport and lithium ion storage, but also a binder which ensures mechanical cohesion of the electrode material. Conventional binders are binders based on polyvinylidene fluoride, based on acrylic acid or based on cellulose which contain electrically conductive additives such as carbon black, carbon nanotubes and the like in order to provide the necessary electrical conductivity. However, such electrode compositions are not sufficiently stable under the required charging and discharging conditions. Volume expansion of the electrode material is often accompanied by irreversible damage which significantly reduces the life of the lithium ion battery.

It is an object of the present invention to provide a composite electrode for use in lithium ion batteries which displays a reduced volume expansion or volume contraction during charging and discharging processes, compensates for irreversible damage by intrinsic elasticity of the electrode material, and has increased conductivity. A further object of the invention is to provide an electrochemical cell, in particular a lithium ion cell/battery, having a high energy density and high charging and discharging rates, and a long cell/battery life.

The present invention relates to a composite electrode for use in electrochemical cells, in particular for use in lithium ion cells or lithium ion battery cells, having a composition which includes an elastic, conductive polymeric binder and a conversion material. As used herein, a conversion material is a chemical compound which contains at least one transition metal M and an anion X. For example, the conversion material can contain combinations of various transition metals, optionally with one or more anions. The transition metal is fully reducible in a cell charging process of the electrochemical cell. The conversion material described in the present disclosure can be used alone or a combination of various conversion materials can be used. Suitable known conversion materials are described, for example, in Jordi Cabana et al., “Beyond Intercalation-Based Li-Ion Batteries: The State of the Art and Challenges of Electrode Materials Reacting Through Conversion Reactions”, Adv. Mater., 2010, 22, E170-E192. Known examples of conversion materials include FeF₃, BiF₃, TiF₃, VF₃, FeF₂, CoF₂, NiF₂, CuS, MnS, CoS₂, AgCl, CuCl₂, Co₃N, Cu₃N, Fe₃N, Ni₃N and MnP₄.

Depending on the design of the electrochemical cell for which the composite electrode of the invention is employed, the composite electrode can be configured as an anode or as a cathode.

However, the sole use of the conversion material in the electrode materials for lithium ion batteries is not sufficient to overcome the disadvantages of the prior art. In one aspect of the invention, the conversion material is therefore used together with an elastic, conductive polymeric binder. Owing to its chemical structure, such a binder is electrically conductive and also conducts lithium ions. For this reason, the use of conductive polymer binder eliminates the necessity of conductive additive or greatly reduces the conductive additive amount necessary. Conductivity additives in conventional binder systems composed of polyvinylidene fluoride and the like are added in conventional composite electrodes in order to provide satisfactory and rapid electron transport or lithium ion transport in the composite electrode during use or charging of the electrodes. Use of conductive polymeric binders, in particular with a reduced amount of conductivity additives in the binder, has been found to be advantageous for the achievement of high charging and discharging rates combined with a reduction in volume changes. Without wishing to be bound by theory, it is assumed that the conductivity additives present in conventional composite electrodes hinder volume changes in the composite electrode during lithium ion intercalation and liberation of lithium ions and thus reduce the life of the cell. The conductive polymeric binder according to the invention in combination with a conversion material which has no added conductivity additive or a reduced amount of conductivity additive ensures a composite electrode for use in electrochemical cells having a high energy density and also provides a good bonding of the active material to a power outlet lead. The composite electrode of the invention also allows high charging and discharging rates without the stability of the composite electrode being adversely affected by the associated volume change. The composite electrode of the invention is therefore particularly suitable for high-capacity applications, as are required and desired in, for example, the automobile sector.

For stability reasons, the conversion material of the invention is preferably present as compound MX or MXY. M is selected from the group consisting of: Fe, Bi, Ti, V, Co, Ni, Cu, Mn and mixtures thereof. The elements indicated here are characterized by a good availability and reliable usability. Fe, Mn, Co and Cu are particularly preferred among the transition metals M.

X is a halide, a nonmetal or a semimetal and is preferably selected from the group consisting of: F, Cl, S, O, N and P.

Y serves to stabilize the conversion material and is preferably selected from the group consisting of the alkali metals and alkaline earth metals, carbon (C) and aluminum (Al). More preferably, Y is selected from the group consisting of: Li, Na, K and C.

To improve the conductivity of the composite electrode of the invention, a conductive additive, also known as a conductivity additive may be included. The conductive additive is selected from the group consisting of: C, Al and Cu. For cost reasons and because of its good availability, preferably the conductive additive contains carbon (C). In particular carbon black or graphite is particularly preferred.

As further active material or as a lithium source, the composite electrode can, e.g., when used in a lithium ion cell or a lithium ion battery, also contain metallic lithium, preferably in dispersed form, such as stabilized lithium metal powder (SLMP).

A ratio of the conversion material to the polymeric binder of 4:1, in particular 9:1 and in particular 99:1, gives a composite electrode having a particularly high energy density. The higher the proportion of the conversion material relative to the proportion of the conductive binder, the higher the energy density. However, above a ratio of conversion material to binder of more than 99:1, the stability of the composite electrode material decreases.

To provide a particularly good elasticity in the binder while improving the electron conductivity, the polymeric binder has an aromatic backbone having polar side groups.

The lithium ion conductivity can be improved by introducing polyethylene oxide side chains into the binder. For example, high electron conductivity can be achieved by the use of a polymeric binder having polyfluorene units and/or benzoic acid units and/or biphenyl units and/or fluorene units in the backbone.

From the point of view of improved lithium ion conductivity combined with a very good electron conductivity, the polymeric binder is preferably (poly(2,7-9,9-dioctylfluorene-co-2,7-9,9-(di(oxy-2,5,8-trixadecane))fluorine-co-2,7-fluorenone-co-2,5-1-methylbenzoate)), also known as PFPFOFOMB.

A particularly stable and highly functional composition for a composite electrode, which can compensate for any volume changes during charging processes or discharging processes, is obtained when the proportion of polymeric binder is from 0.1 to 30% by weight, preferably from 0.5 to 10% by weight, and more preferably, from 1 to 5% by weight, based on the total weight of the conversion material.

Decreases in stability of the composite electrode material can be prevented by the polymeric binder being free of conductive particles as are used in conventional binder systems for providing good electric conductivity.

The present invention also relates to an electrochemical cell, in particular a lithium ion battery cell or a lithium ion battery. The electrochemical cell of the invention includes an anode, a cathode, at least one electrolyte and at least one separator. According to one aspect of the invention, the anode or the cathode or both of these electrodes are formed by a composite electrode of the invention. In the electrochemical cell of the invention, particular preference is given to at least the cathode being formed by the composite electrode of the invention. As for the anode, it is possible to use a conventional anode. A conventional anode is, for example, made up of a typical anode material, e.g., graphite, silicon or Li₄Ti₅O₁₂, a conductive additive and a conventional binder. The electrochemical cell according to the invention does not however necessarily have to contain an anode in the conventional sense. The function of an anode can, for example, also be performed by deposition of lithium from the conversion material onto a power outlet lead. Thus, the term anode in general refers, according to the invention, to a region of the electrochemical cell at which electrons are liberated during the discharging process. The electrochemical cell is characterized by a very high energy density combined with good long-term stability and high discharging rates and charging rates. The electrochemical cell of the invention is particularly suitable for producing a high-performance lithium ion battery, in particular for portable appliances or motor vehicles.

According to another aspect of the invention, the electrochemical cell can further include a power outlet lead. If the cathode is formed by the composite electrode of the invention, the anode is made of a lithium metal foil. The separator here contains one or more solid-state or liquid separators.

According to another aspect of the invention, the electrochemical cell can include metallic lithium, a cathode, one or more electrolytes and one or more separators. The cathode here is formed by the composite electrode of the invention and therefore includes at least one conversion material and an elastic, conductive polymeric binder. To prevent dendritic lithium growth, the electrochemical cell can, according to the invention, also have a thin ceramic protective layer or solid-state electrolyte or a thin layer of SLMP on the metallic lithium. In one example, the lithium can preferably be deposited from the conversion material onto a power outlet lead in order to provide the anode function.

The advantages, advantageous effects and further developments described for the composite electrode of the invention also apply to the electrochemical cell of the invention. Advantageously, the composite electrode of the invention displays a high elasticity which can compensate for any volume changes; prevents crack formation with destruction of the active material; and achieves high charging rates and discharging rates as a result of the electrical and ionic conductivity of the binder. The electrochemical cell formed by the composite electrode of the invention has a high energy density and is particularly suitable for applications which require a high power density.

This and other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a composite electrode in accordance with one or more aspects of the invention.

FIG. 2 illustrates a lithium ion battery cell using the composite electrode of FIG. 1.

### DETAILED DESCRIPTION OF THE DRAWINGS

In the figures, identical reference numerals denote identical elements/components.

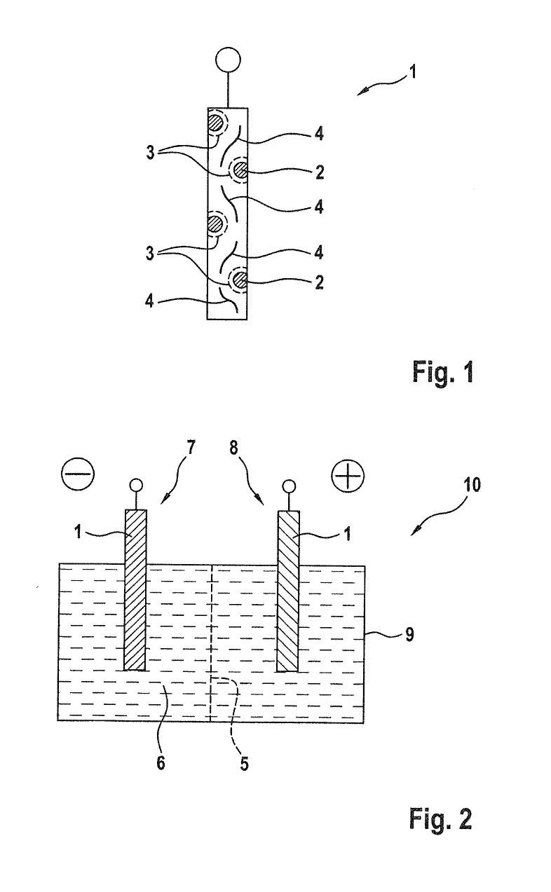

In detail, FIG. 1 shows a composite electrode 1 which can be configured either as an anode or as a cathode in an electrochemical cell. The composite electrode 1 is provided for use in an electrochemical cell, in particular for use in a lithium ion battery cell, which contains a conductive additive, i.e., a conductivity additive 2, a conversion material 3 and an elastic, conductive polymeric binder 4. The conversion material 3 serves as a storage for the lithium ions and can intercalate or liberate the lithium ions. The conversion material is in the form of a compound MX or MXY, where M is a transition metal and is selected from the group consisting of: Fe, Bi, Ti, V, Co, Ni, Cu, Mn and mixtures thereof, X is an anion, in particular a halide, a nonmetal or a semimetal, and Y is preferably selected from the group consisting of: alkali metals and alkaline earth metals, C and Al. The transition metal is completely reducible in a cell charging process of the electrochemical cell.

The elastic, conductive polymeric binder 4 produces a bond between the conversion material 3 and the conductively additive 2, so that the composite electrode 1 has satisfactory mechanical stability. The polymeric binder 4 is elastic and partly compensates for any volume changes which can occur during charging processes or discharging processes of the electrode material, without crack formation in the material occurring. Due to its electrical conductivity and its lithium ion conductivity, the polymeric binder 4 can at the same time act as a conductive additive, so that the conductivity additive 2 can be excluded. This increases the gravimetric energy density of the cell and also reduces cost. The polymeric binder 4 is thus advantageously free of conductivity additives 2. The composite electrode 1 displays a high energy density.

FIG. 2 is a schematic depiction of a lithium ion battery cell 10. This comprises two electrodes which are each formed by the composite electrode 1 of FIG. 1. One composite electrode 1 is configured as anode 7 and one composite electrode 1 is configured as cathode 8. The anode 7 and the cathode 8 are assembled to form a cell and introduced into a container 9 which is filled with electrolyte 6. A separator 5 separates the anode side of the cell 10 from the cathode side. The use of the composite electrode 1 of the invention as anode 7 and as cathode 8 provides a lithium ion battery cell 10 with a high energy density and good charging rates and discharging rates.

The above description of the present invention serves only for illustrative purposes and not for the purpose of restricting the invention. Various alterations and modifications are possible within the framework of the invention, without going outside the scope of the invention and its equivalents.

### LIST OF REFERENCE NUMERALS

1 Composite electrode material

2 Conductivity additive

3 Conversion material

4 Binder

5 Separator

6 Electrolyte

7 Anode

8 Cathode

9 Container

10 Lithium ion battery cell

What is claimed is:

1. A composite electrode for use in an electrochemical cell, comprising an elastic, conductive polymeric binder and a conversion material; wherein the conversion material comprises at least one transition metal M and an anion X, and wherein the transition metal M is completely reducible in a charging process of the electrochemical cell.

2. The composite electrode according to claim 1, wherein the conversion material is present as compound MX or MXY, wherein the M is selected from the group consisting of: Fe, Bi, Ti, V, Co, Ni, Cu, Mn and mixtures thereof.

3. The composite electrode according to claim 2, wherein the M is Fe, Mn, Co or Cu.

4. The composite electrode according to claim 2, wherein the X is a halide, a nonmetal or a semimetal.

5. The composite electrode according to claim 4, wherein the X is selected from the group consisting of: F, Cl, S, O, N and P.

6. The composite electrode according to claim 2, wherein the Y is selected from the group consisting of alkali metals, alkaline earth metals, C and Al.

7. The composite electrode according to claim 1, further comprises a conductive additive, wherein the conductive additive is selected from the group consisting of: C, Al and Cu.

8. The composite electrode according to claim 7, wherein the conductive additive contains C.

9. The composite electrode according to claim 1, wherein the composite electrode contains metallic lithium.

10. The composite electrode according to claim 1, wherein the ratio of the conversion material to the conductive polymeric binder is 4:1.

11. The composite electrode according to claim 1, wherein the ratio of the conversion material to the conductive polymeric binder is 9:1.

12. The composite electrode according to claim 1, wherein the ratio of the conversion material to the polymeric binder is 99:1.

13. The composite electrode according to claim 1, wherein the conductive polymeric binder has an aromatic backbone with polar side groups.

14. The composite electrode according to claim 13, wherein the conductive polymeric binder has polyethylene oxide side chains and/or polyfluorene units and/or benzoic acid units and/or biphenyl units and/or fluorene units in the backbone.

15. The composite electrode according to claim 1, wherein the conductive polymeric binder is (poly(2,7-9,9-dioctylfluorene-co-2,7-9,9-(di(oxy-2,5,8-trixadecane))fluorine-co-2,7-fluorenone-co-2,5-1-methylbenzoate)).

16. The composite electrode according to claim 1, wherein the conductive polymeric binder is present from 0.1 to 30% by weight, based on the total weight of the conversion material.

17. The composite electrode according to claim 1, wherein the conductive polymeric binder is present from 0.5 to 10% by weight, based on the total weight of the conversion material.

18. The composite electrode according to claim 1, wherein the conductive polymeric binder is present from 1 to 5% by weight, based on the total weight of the conversion material.

19. An electrochemical cell comprising an anode, a cathode, at least one electrolyte and at least one separator, wherein the cathode and/or the anode is formed by a composite electrode according to claim 1.

20. The electrochemical cell according to claim 19, further comprising a power outlet lead, an anion made of a lithium metal foil or liquid lithium, wherein the separator contains one or more solid-state or liquid separators.
